(19) United States
(12) Patent Application Publication
(10) Pub. No.: US 2015/0217191 A1
(43) Pub. Date: Aug. 6, 2015

(54) GAME CONTROLLER ADAPTED FOR A MULTITUDE OF GAMING PLATFORMS

(71) Applicant: Kelvin Yan, Brea, CA (US)

(72) Inventor: Kelvin Yan, Brea, CA (US)

(21) Appl. No.: 14/452,444

(22) Filed: Aug. 5, 2014

Related U.S. Application Data
(60) Provisional application No. 61/935,435, filed on Feb. 4, 2014.

(51) Int. Cl. A63F 13/235

(52) U.S. Cl. CPC A63F 13/235

(57) ABSTRACT

The present invention relates in general to a game controller that stores pairing information for multiple host devices and includes a module that enables switching communication between the controller and the multiple host devices in near real-time. In one embodiment of the present invention, a game controller includes a pairing module and a switching module that facilitates near real-time switching communication between gaming platforms, the communication occurring through means such as, but not limited to, radio frequency communication or Bluetooth® communication. A controller according to the invention enables users to circumvent initial pairing procedures required when switching between gaming platforms that may host a compatible gaming controller.

### PRIORITY NOTICE

The present application claims priority under 35 U.S.C. §119(e) to U.S. Provisional Patent Application Ser. No. 61/935,435 filed on Feb. 4, 2014, the disclosure of which is incorporated herein by reference in its entirety.

### TECHNICAL FIELD OF THE INVENTION

The present invention relates in general to a game controller adapted for a multitude of gaming platforms, and more specifically, to a game controller that stores pairing information for multiple host devices and includes an interface that enables switching communication between the controller and the multiple host devices in near real-time.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Video game controllers help gaming platform users interact with the imaginative or representative worlds created by video game designers. These game controllers serve as the communicatory intermediaries between a user and a gaming platform and translate the pressing of buttons into actions we see on our gaming displays. Despite their convenience as a user-gaming platform communication means, these game controllers are typically only compatible with a single gaming platform, severely limiting their individual applicability in the sphere of video gaming. Furthermore, with the ever growing field of mobile device gaming, there is an increasing need for controllers suitable for mobile gaming platforms such as mobile phones, and tablets. More specifically, the prior art lacks controllers that may be used at home, or on the go, and which require no additional steps to switch communication between multiple gaming platforms.

Therefore, there is a strong need in the art for versatile game controllers that may communicate with multiple gaming platforms, such as mobile gaming platforms, and which may easily switch communication between these multiple gaming platforms in near real-time. It is to these ends that the present invention has been developed.

### BRIEF SUMMARY OF THE INVENTION

To minimize the limitations in the prior art, and to minimize other limitations that will be apparent upon reading and understanding the present specification, the present invention describes a game controller adapted for a multitude of gaming platforms, for example, a game controller that stores pairing information for multiple host devices and includes an interface that enables switching communication between the controller and the multiple host devices in near real-time.

A wireless game controller, in accordance with one embodiment of the present invention, comprises: a processor for enabling one or more modules; a memory for storing one or more pairing details related to one or more host devices; a pairing module for retrieving the one or more pairing details stored in the memory; a communications module for wirelessly communicating with the one or more host devices, when one of the one or more host devices is in a paired communication with the wireless game controller; and a switching module for switching communication, in near real-time, between one of the one or more host devices and the game controller wherein the switching module is configured to communicate with the pairing module.

A wireless game controller, in accordance with another embodiment of the present invention, comprises: a memory; a switching interface; and a processor configured to: receive a first request, via the switching interface, to store in the memory a first pairing data associated with a first host device; receive a second request, via the switching interface, to store in the memory a second pairing data associated with a second host device; establish a first wireless paired communication between the game controller and the first host device; and switch from the first wireless paired communication between the game controller and the first host device, to a second wireless paired communication that is established between the game controller and the second host device in near real-time.

A wireless game controller configured to enable switching communication between a plurality of gaming platforms, in accordance with yet another embodiment of the present invention, comprises: a memory for storing one or more pairing details related to one or more host devices; a wireless communication interface for wirelessly communicating with the one or more host devices, wherein the one or more host devices are paired to the wireless game controller using the one or more pairing details; a processor for sending and receiving the one or more pairing details via the wireless communication module; and a switching module for switching communication, in near real-time, between the one or more host devices and the game controller.

It is an objective of the present invention to provide a game controller permitting a user to switch between a variety of different gaming platforms in near real-time by engaging a switching interface.

It is another objective of the present invention to provide a user with the capability to purchase a single controller to control many gaming platforms, and eliminate the costly need to purchase a different controller for each gaming platform with native controller support.

It is yet another objective of the present invention to provide a game controller that is transportable and versatile, enabling pre-programmed pairing with multiple gaming platforms including desktop computers and mobile devices.

These and other advantages and features of the present invention are described herein with specificity so as to make the present invention understandable to one of ordinary skill in the art.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 depicts a gaming controller device, in accordance with one embodiment of the present invention, which may communicate with a plurality of host devices, or multiple gaming platforms.

FIG. 2 is a box diagram depicting the components of and the wireless connection between a wireless game controller and a multitude of host devices, collectively referred to as system 200.

FIG. 3 depicts a block diagram illustrating different modules in accordance with the present invention, which facilitate the pairing of a game controller to multiple gaming platforms, and enables real-time switching between gaming platforms.

FIG. 4 depicts a flowchart illustrating a method of storing pairing information for multiple host devices from a controller that includes an interface, which enables switching communication between the controller and the multiple host devices in near real-time.

FIG. 5 depicts a flowchart illustrating a method of switching communication between the controller and multiple host devices in near real-time, via a switching interface on the gaming controller.

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

Within this disclosure both “video games” and “computer games” are referred to as “video games.” A “game controller” refers to an apparatus that is configured to allow a user to interact with a video game running on a host device or gaming platform. A “gaming platform” refers to a host device, such as a computer, which runs software that includes video games. A gaming platform may, for instance, comprise a video game console (Xbox®, Playstation, Wii®, Steam Box™ etc. . . . ), a handheld video game device, a smart device (smartphone, iPhone®, iPad, tablet, iPod Touch® etc. . . . ), or a computer (PC, laptop, MacBook, iMac®, desktop etc. . . . ). Some gaming platforms are almost exclusively used as a gaming platform, while other gaming platforms may have other uses. For example, “console devices” have traditionally been utilized almost exclusively for gaming, but modernly have other uses, such as general entertainment purposes (e.g. watching movies and browsing the internet); thus, for purposes of this disclosure, gaming controllers may be utilized for interacting with games in addition to various other entertainment functions.

Presently, many electronic devices, whether mobile or not, may also generally be used as a gaming platform. For example, personal computers (PCs), desktop computers, laptops computers, smartphones, and tablet computing devices may all be used as gaming platforms to run software including video games. This broadening landscape for video games produces an emerging need for a controller capable of communicating with a multitude of gaming platforms in near real-time.

Generally, the invention involves a gaming controller device that stores pairing information for multiple host devices and includes an interface that enables switching communication between the device and the multiple host devices in near real-time. By implementing a memory and a switching interface, the device may be enabled for storing pairing data associated with multiple host devices and for switching communication between the device and the multiple host devices in near-real time. This circumvents the cumbersome pairing procedure typically required when pairing a controller to a gaming platform. Since the memory may be configured for storing multiple host devices' pairing data, all which is required to switch communication between previously paired host devices is activation of the switching interface. In one embodiment of the invention, a pairing module detects the activation of the switching interface, and designates newly generated data packets with the selected destination associated with the desired host device—the pairing information of which is stored in the controller's memory. For example, a user may store pairing data for multiple host devices, or gaming platforms, such as a desktop computer, a tablet, and a smartphone. Once the pairing data for each gaming platform is stored on the memory of the device, the user may switch between gaming platforms by activating the switching interface on the device. In exemplary embodiments, the switching interface on the device comprises a plurality of buttons, wherein each button is designated for each host device.

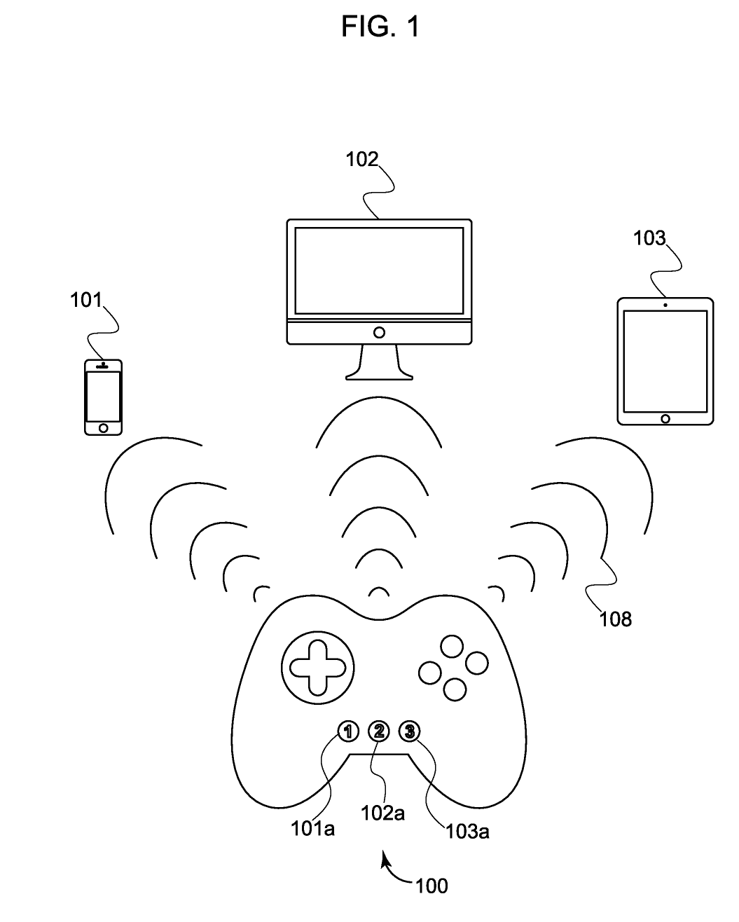

Turning now to the figures, FIG. 1 depicts a gaming controller device, in accordance with one embodiment of the present invention, which may communicate with a plurality of host devices, or multiple gaming platforms. More specifically, FIG. 1 depicts device 100, first gaming platform 101, second gaming platform 102, and third gaming platform 103. Once device 100 has stored each host devices' pairing data on a memory, device 100 may communicate with each of the various host devices or gaming platforms 101, 102, or 103, by engaging or activating one of the corresponding switching interfaces 101a, 102a, or 103a—each switching interface associated with one of the host devices. Typically, device 100 is configured to communicate with a single host device at a time, thus if engaging or activating switching interface 101a enables device 100 to communicate with gaming platform 101, device 100 will cease communication with a previously connected host device such as either gaming platform 102 or 103.

Device 100 may be a game controller that is ergonomically designed to afford comfortable use for the user, even during long periods of use. Thus, device 100 may have a controller body or housing designed to roughly contour to the user's hands according to how device 100 is most appropriately held. Additionally, a body or housing design for device 100 is meant to afford ease of interaction with the various buttons, tabs, bumpers, analog sticks, directional pads, audio jacks, and other device 100 features common to handheld controllers.

In an exemplary embodiment, device 100 may be roughly symmetrical, with a left side designed to contour to the user's left hand, and a right side designed to contour to the user's right hand, wherein the user uses both hands simultaneously. In this exemplary embodiment, approximately the central third of the controller does not extend as far downward (if observing the controller in the manner presented in FIG. 1) as the left and right thirds of the controller so as to provide the user a comfortable means to wrap each hand around the respective outer contoured pieces without obstruction.

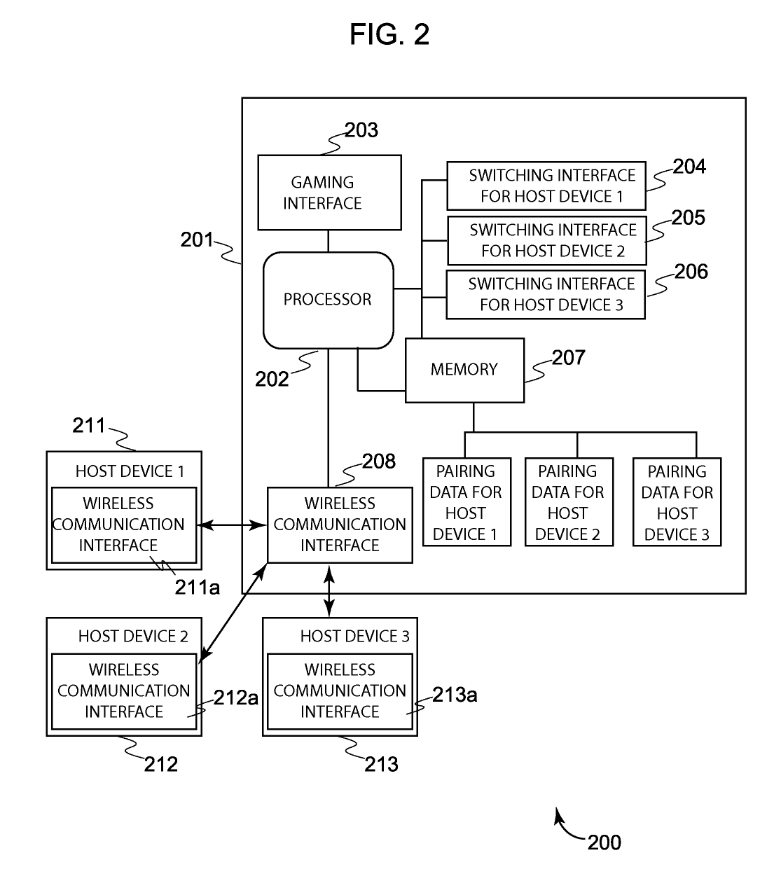

Device 100 may be adapted to permit a user to switch between first gaming platform 101, second gaming platform 102, and third gaming platform 103 in near real-time via wireless communication 108. Wireless communication 108 enables communication between device 100 and the various gaming platforms 101, 102, and 103. Wireless communication 108 is multidirectional, and may be achieved with known wireless communication interfaces, such as those of the game controller and the gaming platforms discussed in FIG. 2.

As an illustrative example of use of the present invention, a user may play a game on gaming platform 101, which may be a mobile device such as an iPhone; after arriving home, the user may immediately switch to playing a game on gaming platform 102, which may be a desktop computer such as an iMac®, and later again switch to playing a game on gaming platform 103, which may be another device such as an iPad. These gaming platforms are illustrative only, and other gaming platforms may be substituted in their place.

Typically, when device 100 is configured to communicate with first gaming platform 101, and the user desires to switch to second gaming platform 102, the user may engage second switching interface 102a, which may be programmed such that when engaged, device 100 pairs in near real time to second gaming platform 102. Similarly, if the same user desires to switch to third gaming platform 103, the user may engage third switching interface 103a, which may be programmed such that when engaged, device 100 pairs in near real time to third gaming platform 103. Finally, if the user desires to switch back to first gaming platform 101, the user may engage first switching interface 101a, which may be programmed such that when engaged, device 100 pairs in near real time back to first gaming platform 101. As described, the user may switch between any of the host devices or gaming platforms described above in near real time by engaging or activating the switching interface associated with the desired gaming platform.

Each switching interface may be further programmed to operate with a diverse array of gaming platforms. For example, first switching interface 101a may be initially programmed to pair with an iPhone. This initial pairing configuration may be altered at any time in the future. As such, first switching interface 101a could thereafter be altered to pair with an iMac®.

Many other pair configurations are possible in light of the diverse array of gaming platforms available on the market. For example, and without limiting the scope of the present invention, device 100 may store pairing data for different host devices with which device 100 is configured to communicate with. In one embodiment, device 100 may communicate only with Bluetooth® enabled host devices, including gaming consoles, personal computers, smartphones, tablets, and other devices that have a Bluetooth® interface. In another embodiment, device 100 may communicate only via proprietary radio frequency protocols or RF enabled host devices, including gaming consoles, personal computers, smartphones, tablets, and other devices that have such an RF interface. In yet other embodiments, device 100 may communicate via both Bluetooth® or RF enabled host devices, including gaming consoles, personal computers, smartphones, tablets, and other devices that have both an RF and a Bluetooth® interface. Typically, it is desirable to utilize a single communication protocol to minimize controller components; thus, device 100 may typically comprise a wireless interface that utilizes a single popular wireless communication protocol.

The switching interfaces may be implemented in any conceivable location on device 100. For example, the switching interfaces may be placed atop the front of device 100 or, as depicted in the present embodiment, along the bottom half of the front of device 100, exemplarily roughly centered along this face. Ideally, the location or locations of the switching interfaces may be anywhere in which the switching interfaces are easily reachable on device 100, yet do not have an unreasonable likelihood of being accidentally pressed while interacting with another button, trigger, or the like, of device 100.

Device 100 may be equipped with a memory configured to store pairing details or pairing data of multiple host devices or gaming platforms. This stored pairing data eliminates the need to require an initial pairing procedure each time the device communicates with a different host device, which may be achieved by activation of the switching interfaces. This feature allows a user to instantaneously switch from one gaming platform to the next without having to execute the typical initial pairing procedure because rather than having to, for example, re-exchange device address between device 100 and a host device, device 100 has this information stored in its memory.

Turning to the next figure, FIG. 2 is a box diagram depicting the components of and the wireless connection between a wireless game controller and multiple host devices, collectively referred to as system 200. System 200 comprises wireless game controller (game controller 201) and host devices 211, 212, and 213, with game controller 201 further comprising processor 202, a standard game controller interface (gaming interface 203), first switching interface 204, second switching interface 205, third switching interface 206, memory 207, and wireless communication interface 208. Game controller 201 is configured to communicate with first, second, and third host devices 211, 212, and 213—each host device comprising their own wireless communication interfaces 211a, 212a, 213a, respectively.

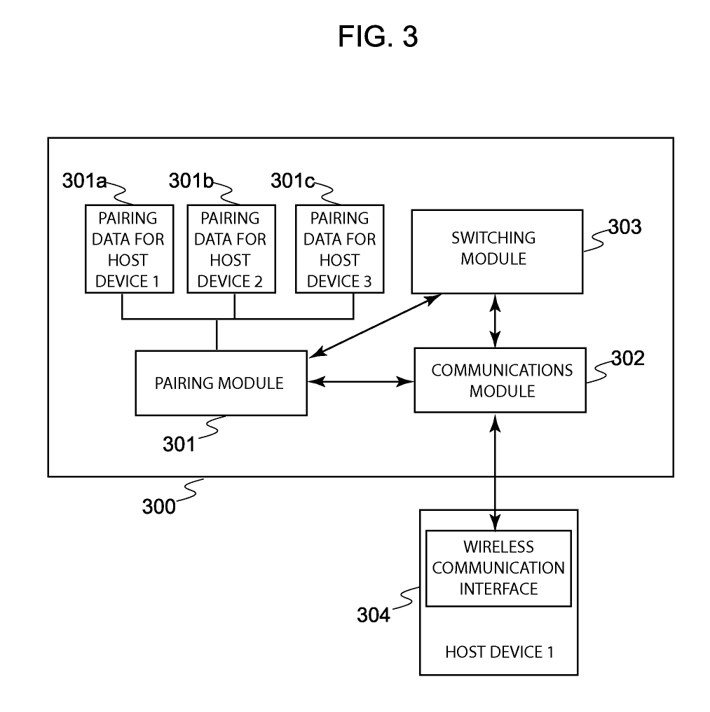

Processor 202 may be any type of processor, microprocessor, or include one or more processors suitable to execute the various functions of game controller 201. Typically, processor 202 may run or execute one or more set of instructions that may be stored in memory 207 to perform the various functions of game controller 201. For example, processor 202 may be configured to relay information pertaining to a host device pairing data between different modules of game controller 201. (See FIG. 3). Thus, processor 202 may enable the retrieving of host device pairing data from memory 207, and the designation of the retrieved pairing data to data packets generated during communication between game controller 201 and one of host devices 211, 212, and 213.

Gaming interface 203 generally comprises one or more inputs such as buttons, tabs, bumpers, analog sticks (also referred to as thumbsticks, sticks, joysticks etc. . . . ), directional pads, audio jacks, charging inputs, or any other similar feature on a game controller interface. Many of these features, such as the buttons, tabs, bumpers, analog sticks, and directional pads, serve to manipulate what the user sees on their gaming display. Thus, gaming interface 203 may be any set of user input devices to enable game play.

First, second, and third switching interfaces 204, 205, 206 are interfaces which, when selected, pair game controller 201 in near real time to the host device associated with the selected switching interface. For example, first switching interface 204 may be configured to pair game controller 201 to host device 211, second switching interface 205 may be configured to pair game controller 201 to host device 212, and third switching interface 206 may be configured to pair game controller 201 to host device 213. Furthermore, although FIG. 2 displays three switching interfaces, more or less switching interfaces may be utilized without limiting or deviating from the scope of the present invention. Typically, the gaming platform associated with a given switching interface may be changed by a user at any point. For example, if first switching interface 204 is initially linked with host device 211, for example a user's iPad, and the user subsequently purchases a new iPad, the initial link may be erased or overwritten with that of the new iPad. Alternatively, the old iPad® may continue to be configured to first switching interface 204, while the new iPad may be configured to second or third switching interfaces 205, 206. Thus, each switching interface comprises an input device that may signal processor 202 to store or retrieve pairing data associated with host devices 211, 212, and 213.

Memory 207 stores the pairing details or pairing data associated with multiple host devices. Typically, memory 207 includes memory space designated or allocated for storing pairing data for the number of host devices game controller 201 is capable of pairing—this typically depending on the number of switching interfaces. Hence, memory 207 has memory space allocated to store pairing data for host devices 211, 212, and 213. Pairing data may be any suitable device identifier, which enables game controller 201 and host devices 211, 212, and 213 to authenticate each other and establish a wireless connection. Pairing data may be a relatively static, predictable, or dependably pair-able identifier that does not necessitate cumbersome or frequent recalibrations and reentries of the pertinent identifier information. In one embodiment, this identifier is a device ID of the gaming platform. In another embodiment, the identifier may be a media access control address (MAC address). Still other identifiers may be employed without deviating from the scope of the present invention.

Wireless communication interface 208 enables wireless communication between game controller 201 and host devices 211, 212, and 213. In one embodiment, wireless communication interface 208 may include a Bluetooth® interface. In another embodiment, wireless communication interface 208 may include a radio frequency interface. In a third embodiment, this communication may occur via infrared communication. In other embodiments, the wireless communication may occur using a wireless personal area network (WPAN). Alternatively, other forms of communication such as Wi-Fi® may utilize a wireless local area network (WLAN) to communicate. In yet other embodiments, alternatives to the enumerated methods of communication between a game controller and gaming platform may be used without deviating from the scope of the present invention.

Each of host device 211, host device 212, and host device 213 comprise their own individual wireless communications interfaces 211a, 212a, 213a, which are compatible with wireless communication interface 208. In one embodiment, with every packet or bit of data sent or received by wireless communication interface 208 of game controller 201, pairing data stored in memory 207 is sent along with data packets sent between game controller 201 and one of the host devices 211, 212, or 213—which ever host device game controller 201 is in present communication.

As is well known in the art, each of host device 211, host device 212, and host device 213 may require drivers or the like to permit this actionable communication. Such drivers may be preloaded or downloaded to the given gaming platform, or transferred to the gaming platform via a connecting cable or external device such as a USB cable or portable USB stick, in addition to any other method of loading drivers onto a device that would be known by a person of ordinary skill in the art. Additionally, such drivers may be created by the gaming platform company, a third-party entity, or the manufacturer of the present invention, among any other conceivable driver-producing entity. In one embodiment, if game controller 201 is paired to a given gaming platform, game controller 201 may communicate with the gaming platform to automatically identify and download the necessary driver or drivers for enabling actionable communication between the two devices. Alternatively, drivers for the most common gaming platforms may be provided or purchasable individually or as a group either with or separate from purchase of game controller 201. Thus, many such options are available for enabling actionable communication between game controller 201 and a given gaming platform once these devices are communicably paired.

Turning to the next figure, FIG. 3 depicts a block diagram illustrating different modules in accordance with the present invention, which facilitate the pairing of a game controller to multiple gaming platforms, and enables real-time switching between gaming platforms. Modules may refer to hardware components or software components designated to perform particular functions. In the present invention, different modules may be implemented for performing the storing, retrieving, of the paired data associated with one or more host devices. Furthermore, one or more modules may be designated for establishing communication between the controller and the host device, and for switching communications between the game controller and a different host device. In the embodiment shown, the game controller (device 300) comprises pairing module 301, communication module 302, and input/output module (I/O 303), device 300 shown in communication or paired with host device 304.

Pairing module 301 may be configured to store and retrieve pairing data for one or more host devices. When storing pairing information, pairing module 301 communicates with communication module 302 in order to receive the pairing details or pairing data associated with the pairing host device. For example, if storing pairing details for host device 304, pairing module receives the pairing data from communication module 302 and stores those details in a designated memory space such as memory space 301a. Similarly, when storing other host devices' pairing data, pairing module 301 may designate a space in the device's memory for storing that pairing data—such as memory space 301b or 301c.

Communication module 302 may be configured to receive and send information between device 300 and host device 304 or any other host device for which pairing data is stored in device 300's memory. Thus, communications module may receive and send data packets containing, for example, command signals between device 300 and host device 304. In one embodiment, when communications module 302 is ready to send a data packet to host device 304, communications module 302 and pairing module 301 communicate in order to designate the data packet with host device 304's pairing data. This data may include device address information or any other information required to establish and maintain the authenticated wireless communication between device 300 and host device 304. During communication between device 300 and host device 304, for example during game play, the data packets may be generated from user inputs received from I/O module 303, which are then forwarded to communications module 302 in order to assign each data packet with the correct pairing data.

I/O module 303 may be configured to receive user input such as the pressing or depressing of switching interfaces, action buttons, joysticks, directional pads, bumpers, or any other input device that makes up device 300. I/O module may be further configured to receive output commands coming from host device 304 such as audio, or other feedback including vibration feedback often implemented in today's video gaming experience. I/O module 303 forwards any input to communication module 302 in order to generate the proper commands or signals that may need to be sent to host device 304. Similarly, I/O module 303 may receive output commands or output signals via communications module 302 and forward those commands or signals to the proper destination in order for the output commands or signals to be properly executed or delivered to the right component.

In one embodiment of the present invention, I/O module 303 is configured to receive a user input that activates a switching interface of device 300. Activation of this switching interface is forwarded to pairing module 301 in order to retrieve the desired pairing data for the desired host device. For example, and without limiting the scope of the present invention, if a switching interface is activated in order to disconnect from further communication with host device 304 and engage communication with host device 2 (not shown), then I/O module 303 receives the proper input (i.e. a user may activate the switching interface for host device 2), and I/O module 303 forwards a request for that host device's pairing data, which is stored in, for example, memory space 301b. Once pairing module retrieves the pairing data, the pairing data may be forwarded to communications module 302 in order to forward the pairing information to host device 2.

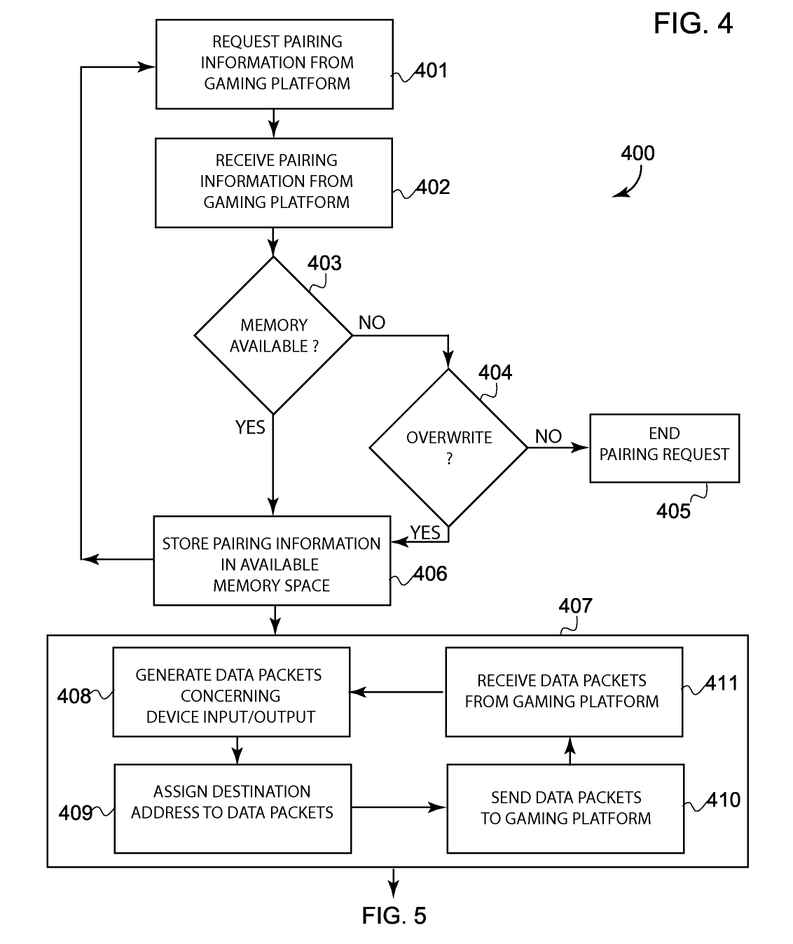

Turning now to the next figure, FIG. 4 depicts a flowchart illustrating a method of storing pairing information for multiple host devices from a controller that includes an interface, which enables switching communication between the controller and the multiple host devices in near real-time. It should be noted that while method 400 is shown and described in a particular sequence, any other conceivable sequence may be practiced without limiting or deviating from the scope of the present invention.

Generally, method 400 comprises requesting pairing data from a host device, receiving the pairing data from the host device, making a determination of where to store the pairing data, and storing the pairing data in an available memory space designated for that host device. This process may be repeated in order to store pairing data for multiple host device. Once paired with the controller, communication may be established between the controller and the host device, wherein the communication may include generating data packets concerning the controllers input, assigning a destination address to the data packets, sending the data packets to the host device, and receiving data packets from the host device as communication between controller and host device continues.

Typically, step 401 comprises of requesting pairing information, or pairing data, from a host device such as a gaming platform. This information may be any device identifying information that may be used to authenticate and establish communication between the game controller and the gaming platform. For example, device information or pairing data may include a MAC address. The request for the host device's pairing information may be initiated by activation of a switching interface, such as a button on the game controller that the user will designate for a particular gaming platform. Once this interface, or button, is engaged or activated, the request may be sent to the host device via a communications module.

In one embodiment, the interface that activates the request is the switching interface, which may be activated by pressing the switching interface for a predetermined set of time. In another embodiment, a different interface is used, such as a different button that is implemented with the game controller for the sole purpose of requesting pairing information from the desired host device. In this later scenario, it may be desirable for the user to be given a user interface in order to select which switching interface to designate as the interface that will enable communication between the game controller and the host device.

In step 402, the host device sends its pairing details to the game controller and the game controller receives the paring data, at which point a determination may be made of where to store the data, or to which switching interface to designate the paring details to.

In step 403, the determination may include simply determining whether memory space is available to store the pairing data. In some embodiments, step 403 may include executing a user interface via a display on the host device, which allows the user to select whether to overwrite previously stored data of another host device, or in step 404, this determination may be made automatically in the event that no other space is available for the new host device's pairing information. If for example, a use is provided with a user interface in order to select whether pairing data will be stored, then the user may elect to end the request in step 405 in the event that the user does not desire to erase previously stored data pertaining to another existing host device with which the user may desire to establish communication at a later time. Alternatively, whether the user is given a choice or not, in step 406 the pairing information or pairing data is stored in the available memory space.

In step 407, communication is established between the game controller and the host device or gaming platform, and typically data packets are exchanged between the two devices. Communication may include step 408, in which data packets concerning game controller inputs and outputs are generated. Communication may also include step 409, in which the data packets that are generated are assigned an identification or destination address so as to maintain the established wireless connection between the game controller and the host device. In step 410, the data packets may be sent to the host device or gaming platform, and in step 411, data packets originating from the host device may be received by the game controller.

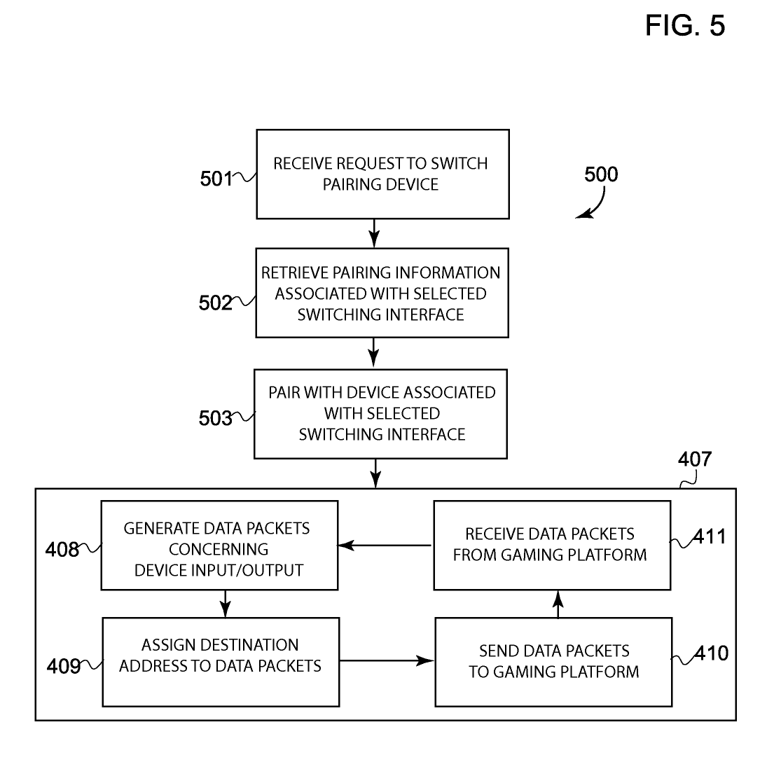

Turning to the last figure, FIG. 5 depicts a flowchart illustrating a method of switching communication between the controller and multiple host devices in near real-time, via a switching interface on the gaming controller. Method 500 may be a continuation of method 400 since a user may store pairing information for a host device and thereafter decide to switch to a different gaming platform or host device. Furthermore, it should be noted that while method 500 is shown and described in a particular sequence, any other conceivable sequence may be practiced without limiting or deviating from the scope of the present invention.

In step 501, a request may be received to switch to a different host device or gaming platform. This may be achieved by receiving a user input of a switching interface located on the gaming controller. Once the switching interface is activated or pressed, a signal with the request to switch pairing devices may be sent, for example, to a paring module.

In step 502, the pairing information or pairing data may be retrieved, wherein the pairing information or pairing data is associated with the selected switching interface and the desired gaming platform. In one embodiment, a pairing module may receive the request in step 501 and then retrieve the pairing data from the memory of the game controller, forwarding the information to a communications module for establishing wireless communication with the desired gaming platform or host device.

In step 503, the desired host device or gaming platform is paired with the gaming controller, and communication, such as in step 407, may commence.

Not only is use of a single game controller for controlling a multitude of gaming platforms convenient, it is also remarkably cost effective. A self-proclaimed gaming enthusiast might own three or more gaming platforms which natively utilize a game controller or which may be aided by use of a game controller. Very often, each gaming platform has its own native or adapted controller, requiring the user to buy at least one of these controllers for each gaming platform, amounting to quite a costly supply. By contrast, in an exemplary embodiment, a single game controller may be configured to communicate with and control a multitude of gaming platforms, saving a user a significant amount of money. Furthermore, the present invention provides a means to communicate with several gaming platforms that might otherwise lack a traditional interface such as game controller.

A game controller adapted for a multitude of gaming platforms has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A wireless game controller, comprising:
a processor for enabling one or more modules;
a memory for storing one or more pairing details related to one or more host devices;
a pairing module for retrieving the one or more pairing details stored in the memory;
a communications module for wirelessly communicating with the one or more host devices, when one of the one or more host devices is in a paired communication with the wireless game controller; and
a switching module for switching communication, in near real-time, between one of the one or more host devices and the game controller wherein the switching module is configured to communicate with the pairing module.

2. The wireless game controller of claim 1, wherein the switching module comprises a user interface that includes an input device for communicating with the pairing module.

3. The wireless game controller of claim 1, wherein the communication module communicates with the one or more host devices via radio frequency.

4. The wireless game controller of claim 1, wherein the communication module communicates with the one or more host devices via Bluetooth.

5. The wireless game controller of claim 1, wherein the communication module communicates with the one or more host devices via a wireless local area network.

6. The wireless game controller of claim 1, wherein the communication module communicates with the one or more host devices via infrared technology.

7. The wireless game controller of claim 1, wherein one of the one or more host devices is a smartphone.

8. The wireless game controller of claim 1, wherein one of the one or more host devices is a tablet.

9. The wireless game controller of claim 1, wherein one of the one or more host devices is a personal computer.

10. A wireless game controller, comprising:
a memory;
a switching interface; and
a processor configured to:
receive a first request, via the switching interface, to store in the memory a first pairing data associated with a first host device;
receive a second request, via the switching interface, to store in the memory a second pairing data associated with a second host device;
establish a first wireless paired communication between the game controller and the first host device; and
switch from the first wireless paired communication between the game controller and the first host device, to a second wireless paired communication that is established between the game controller and the second host device in near real-time.

11. The wireless game controller of claim 10, wherein the switching interface includes a plurality of buttons for establishing the first and second wireless paired communications between the game controller and the first and second host device.

12. The wireless game controller of claim 10, wherein the first and second wireless paired communications are established via a radio frequency interface coupled to the processor.

13. The wireless game controller of claim 10, wherein the first and second wireless paired communications are established via a Bluetooth interface coupled to the processor.

14. The wireless game controller of claim 10, wherein the first and second wireless paired communications are established via a wireless local area network interface coupled to the processor.

15. The wireless game controller of claim 10, wherein the first and second wireless paired communications are established via an infrared interface coupled to the processor.

16. The wireless game controller of claim 10, wherein one of the one or more host devices is a video game console.

17. The wireless game controller of claim 10, wherein one of the one or more host devices is a mobile device.

18. The wireless game controller of claim 10, wherein one of the one or more host devices is a personal computer.

19. A wireless game controller configured to enable switching communication between a plurality of gaming platforms, comprising:
a memory for storing one or more pairing details related to one or more host devices;
a wireless communication interface for wirelessly communicating with the one or more host devices, wherein the one or more host devices are paired to the wireless game controller using the one or more pairing details;
a processor for sending and receiving the one or more pairing details via the wireless communication module; and
a switching module for switching communication, in near real-time, between the one or more host devices and the game controller.

20. The wireless game controller of claim 19, wherein the switching module is configured to:
send a first request to receive and store in the memory a first pairing data associated with a first host device;
send a second request to receive and store in the memory a second pairing data associated with a second host device;
establish a first wireless paired communication between the game controller and the first host device; and
switch from the first wireless paired communication between the game controller and the first host device, to a second wireless paired communication that is established between the game controller and the second host device in near real-time.
